(19) United States
(12) Patent Application Publication
(10) Pub. No.: US 2023/0420854 A1
(43) Pub. Date: Dec. 28, 2023

(54) ANTENNA STRUCTURE AND IMAGE DISPLAY DEVICE INCLUDING THE SAME

(71) Applicant: DONGWOO FINE-CHEM CO., LTD., Jeollabuk-do (KR)

(72) Inventors: Won Hee LEE, Gyeonggi-do (KR); Sung Hoe KIM, Seoul (KR)

(21) Appl. No.: 18/209,631

(22) Filed: Jun. 14, 2023

(30) Foreign Application Priority Data
Jun. 23, 2022 (KR) 10-2022-0076853

(51) Int. Cl. H01Q 9/04; H01Q 1/22; H01Q 21/06; G01S 13/02

(52) U.S. Cl. CPC H01Q 9/045; H01Q 1/22; H01Q 21/065; G01S 13/02

(57) ABSTRACT

An antenna structure may include a first radiation unit including a first radiator and a first transmission line that includes a first feeding portion directly connected to the first radiator and a first line portion connected to an end of the first feeding portion, a second radiation unit including a second radiator that has the same polarization direction as that of the first radiator, and a second transmission line that includes a second feeding portion directly connected to the second radiator and a second line portion connected to an end of the second feeding portion, and a third radiation unit including a third radiator that has the same polarization direction as that of the first radiator, and a third transmission line that includes a third feeding portion directly connected to the third radiator and a third line portion connected to an end of the third feeding portion.

### CROSS-REFERENCE TO RELATED APPLICATION AND CLAIM OF PRIORITY

This application claims the benefit under 35 USC § 119 of Korean Patent Application No. 10-2022-0076853 filed on Jun. 23, 2022, in the Korean Intellectual Property Office (KIPO), the entire disclosure of which is incorporated herein by reference for all purposes.

### BACKGROUND

### 1. Field

The present invention relates to an antenna structure and an image display device including the same. More particularly, the present invention relates to an antenna structure including a plurality of radiators and an image display device including the same.

### 2. Description of the Related Art

As information technologies have been developed, a wireless communication technology such as Wi-Fi, Bluetooth, etc., or a non-contact sensing such as a gesture detection and a motion recognition is being applied to or embedded in image display devices, electronic devices and architecture. For example, an antenna for performing communication in a high frequency or ultra-high frequency band is applied to various mobile devices.

For example, the wireless communication technology is combined with a display device in, e.g., a smartphone form. In this case, the antenna may be combined with the display device to provide a communication function.

As the display device to which the antenna is employed becomes thinner and lighter, a space for the antenna may also decrease. Accordingly, the antenna may be included in the form of a film or patch on a display panel so as to insert the antenna in a limited space.

However, when the antenna is disposed on the display panel, a coaxial circuit for transmitting and receiving signals or performing a feeding may not be easily constructed. Further, sensitivity may be lowered, or spatial efficiency and aesthetic property of a structure to which an antenna device is applied may be hindered due to an insertion of a coaxial power supply circuit.

For example, Korean Patent Publication No. 10-2014-0104968 discloses an antenna device including an antenna element and a ground element.

### SUMMARY

According to an aspect of the present invention, there is provided an antenna structure having improved signaling efficiency and radiation reliability.

According to an aspect of the present invention, there is provided an image display device including the antenna structure.

(1) An antenna structure, including: a first radiation unit including a first radiator and a first transmission line that includes a first feeding portion directly connected to the first radiator and a first line portion connected to an end of the first feeding portion; a second radiation unit including a second radiator that has the same polarization direction as that of the first radiator, and a second transmission line that includes a second feeding portion directly connected to the second radiator and a second line portion connected to an end of the second feeding portion; and a third radiation unit including a third radiator that has the same polarization direction as that of the first radiator, and a third transmission line that includes a third feeding portion directly connected to the third radiator and a third line portion connected to an end of the third feeding portion, wherein the first radiator and the second radiator are arranged along a first direction, and the second radiator and the third radiator are arranged along a second direction perpendicular to the first direction, and two of the first line portion, the second line portion and the third line portion have different feeding directions.

(2) The antenna structure according to the above (1), wherein the first transmission line is disposed at the same layer as that of the first radiator, the second transmission line is disposed at the same layer as that of the second radiator, and the third transmission line is disposed at the same layer as that of the third radiator.

(3) The antenna structure according to the above (1), wherein an extension direction of the first feeding portion, an extension direction of the second feeding portion and an extension direction of the third feeding portion are parallel to each other.

(4) The antenna structure according to the above (3), wherein the third transmission line has a bent portion, and the extension direction of the third feeding portion and an extension direction of the third line portion are perpendicular to each other.

(5) The antenna structure according to the above (4), wherein the first transmission line and the second transmission line each extends in a straight line, and an extension direction of the first transmission line is parallel to an extension direction of the second transmission line, and is perpendicular to the extension direction of the third line portion.

(6) The antenna structure according to the above (5), further including: a first circuit board electrically connected to the first radiation unit and the second radiation unit; and a second circuit board electrically connected to the third radiation unit.

(7) The antenna structure according to the above (4), wherein the second transmission line has a bent portion, the extension direction of the second feeding portion and an extension direction of the second line portion are perpendicular to each other, and the extension direction of the second line portion is parallel to the extension direction of the third line portion, and is perpendicular to an extension direction of the first transmission line.

(8) The antenna structure according to the above (7), further including: a first circuit board electrically connected to the first radiation unit; and a second circuit board electrically connected to the second radiation unit and the third radiation unit.

(9) The antenna structure according to the above (1), further including a fourth radiation unit spaced apart from the first radiation unit, the second radiation unit and the third radiation unit.

(10) The antenna structure according to the above (9), wherein the fourth radiation unit includes a fourth radiator having the same polarization direction as that of the first radiator, and a fourth transmission line connected to the fourth radiator at the same layer as that of the fourth radiator.

(11) The antenna structure according to the above (9), wherein the first radiation unit, the second radiation unit and the third radiation unit are provided as reception radiation units, and the fourth radiation unit is provided as a transmission radiation unit.

(12) The antenna structure according to the above (1), further including a dielectric layer on which the first radiation unit, the second radiation unit and the third radiation unit are disposed, and the first direction is parallel to a width direction of the dielectric layer and the second direction is parallel to a length direction of the dielectric layer.

(13) The antenna structure according to the above (12), wherein a bottom side of the first radiator and a bottom side of the second radiator are adjacent to an edge in the width direction of the dielectric layer, and a lateral side of the second radiator and a lateral side of the third radiator are adjacent to an edge in the length direction of the dielectric layer.

(14) The antenna structure according to the above (1), wherein the first radiator, the second radiator and the third radiator each has a mesh structure, and the first transmission line, the second transmission line and the third transmission line each includes solid structure.

(15) The antenna structure according to claim 14, wherein the first feeding portion, the second feeding portion and the third feeding portion each has a mesh structure, and the first line portion, the second line portion and the third line portion each has the solid structure.

(16) A motion recognition sensor including the antenna structure according to the above-described embodiments.

(17) A radar sensor including an antenna structure according to the above-described embodiments.

(18) An image display device, including: a display panel; and the antenna structure according to the above-described embodiments disposed on the display panel.

(19) The image display device according to the above (18), wherein the first direction is parallel to a width direction of the display panel, and the second direction is parallel to a length direction of the display panel, and the second radiator among the first radiator, the second radiator and the third radiator is most adjacent to one of corner portions of the display panel.

(20) The image display device according to the above (18), further including: a motion sensor driving circuit coupled to the antenna structure; and a flexible printed circuit board (FPCB) electrically connecting the antenna structure and the motion sensor driving circuit.

According to embodiments of the present invention, an antenna structure may include a first radiator, a second radiator and a third radiator which may be driven independently from each other. A first direction in which the first radiator and the second radiator are arranged and a second direction in which the third radiator and the second radiator are arranged may be perpendicular to each other. Accordingly, a signal change in two directions perpendicular to each other may be measured to detect a motion or a distance of a sensing target.

The antenna structure may include a transmission line connected to each of the radiators. The transmission line may include a feeding portion connected to the radiator and a line portion to the feeding portion. The first radiator, the second radiator, and the third radiator may form the same polarization properties, and two of a first line portion, a second line portion and a third portion unit may have different feeding directions. The line portions may be disposed toward one side of the antenna structure avoiding a region where the radiator is disposed to facilitate an antenna feeding design. Accordingly, transmission lines connected to each of the radiators may be designed to have similar lengths, and a line resistance increase and a signal loss may be prevented.

Extending directions of the feeding portions may be parallel to each other. Accordingly, polarization directions of the radiators may coincide with each other, and gain and signal sensitivity of the antenna structure may be improved, thereby improving sensing performance.

The antenna structure may further include a transmission radiator. The antenna structure may be electrically coupled to a motion sensor driving circuit or a radar processor through a circuit board. Signal information obtained from electromagnetic waves reflected from a sensing target may be transmitted to the motion sensor driving circuit or the radar processor, and a motion, a position and a distance of the sensing target may be measured based on the collected information.

### BRIEF DESCRIPTION OF THE DRAWINGS

FIGS. 1 and 2 are schematic plan views illustrating antenna structures in accordance with exemplary embodiments.

FIG. 3 is a schematic plan view illustrating an antenna structure in accordance with exemplary embodiments.

FIG. 4 is a schematic plan view illustrating an antenna structure in accordance with exemplary embodiments.

FIG. 5 is a schematic plan view illustrating an antenna structure in accordance with exemplary embodiments.

FIGS. 6 and 7 are a schematic plan view and a cross-sectional view illustrating an image display device in accordance with exemplary embodiments.

### DETAILED DESCRIPTION OF THE EMBODIMENTS

According to exemplary embodiments of the present invention, an antenna structure including a plurality of radiators arranged in two perpendicular directions.

According to exemplary embodiments of the present invention, an image display device including the antenna structure is also provided. However, an application of the antenna structure is not limited to the display device, and the antenna structure may be applied to various objects or structures such as a vehicle, a home electronic appliance, an architecture, etc.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “third”, “fourth”, “one end”, “other end”, “upper side”, “lower side”, “upper side”, “lower side”, etc., as used herein are not intended to limit an absolute position or order, but is used in a relative sense to distinguish different components or elements.

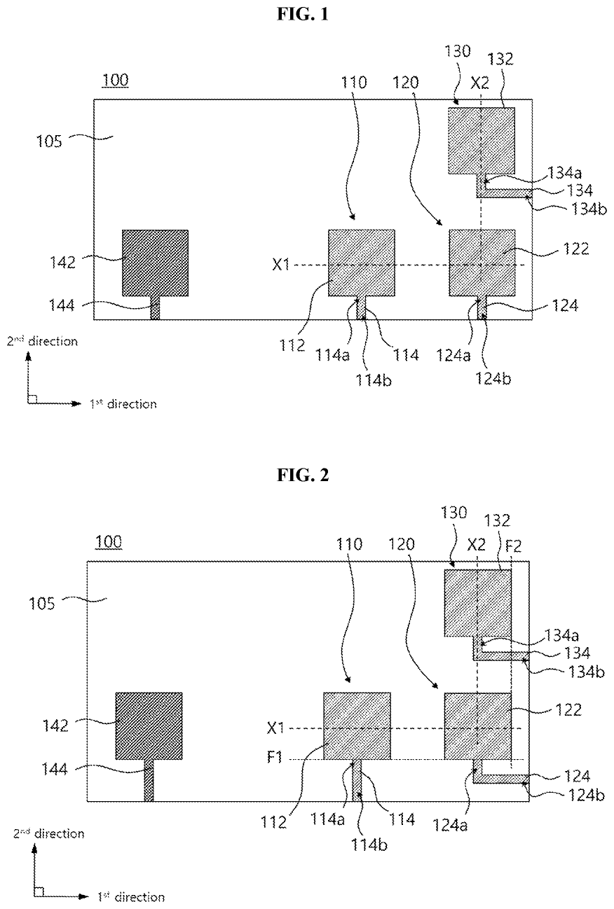

FIGS. 1 and 2 are schematic plan views illustrating antenna structures in accordance with exemplary embodiments.

Referring to FIG. 1, the antenna structure may include a dielectric layer 105, and a first radiation unit 110, a second radiation unit 120 and a third radiation unit 130 disposed on the dielectric layer 105.

The dielectric layer 105 may include, e.g., a transparent resin material. For example, the dielectric layer 105 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more thereof.

The dielectric layer 105 may include an adhesive material such as an optically clear adhesive (OCA), an optically clear resin (OCR), or the like. In some embodiments, the dielectric layer 105 may include an inorganic insulating material such as glass, silicon oxide, silicon nitride, silicon oxynitride, etc.

In an embodiment, the dielectric layer 105 may be provided as a substantially single layer.

In an embodiment, the dielectric layer 105 may include a multi-layered structure of at least two layers. For example, the dielectric layer 105 may include a substrate layer and an antenna dielectric layer, and may include an adhesive layer between the substrate layer and the antenna dielectric layer.

Capacitance or inductance for the antenna structure 100 may be formed by the dielectric layer 105, so that a frequency band at which the antenna structure may be driven or operated may be adjusted. In some embodiments, a dielectric constant of the dielectric layer 105 may be adjusted in a range from about 1.5 to about 12. If the dielectric constant exceeds about 12, a driving frequency may be excessively decreased, and driving in a desired high frequency or ultrahigh frequency band may not be implemented.

In some embodiments, a ground layer may be disposed on a bottom surface of the dielectric layer 105. Generation of an electric field in a transmission line may be more promoted by the ground layer, and an electrical noise around the transmission line may be absorbed or shielded.

In some embodiments, the ground layer may be included an individual member of the antenna structure 100. In some embodiments, a conductive member of an image display device to which the antenna structure 100 is applied may serve as the ground layer.

For example, the conductive member may include various electrodes or wirings such as, e.g., a gate electrode, a source/drain electrode, a pixel electrode, a common electrode, a scan line, a data line, etc., included in a thin film transistor (TFT) array of a display panel.

In an embodiment, a metallic member disposed at a rear portion of the display device such as a SUS plate, a sensor member such as a digitizer, a heat dissipation sheet, etc., may serve as the ground layer.

In example embodiments, the first radiation unit 110, the second radiation unit 120 and the third radiation unit 130 may be physically spaced apart from each other on the dielectric layer 105.

The first radiation unit 110 may include a first radiator 112 and a first transmission line 114 connected to the first radiator 112. The second radiation unit 120 may include a second radiator 122 and a second transmission line 124 connected to the second radiator 122. The third radiation unit 130 may include a third radiator 132 and a third transmission line 134 connected to the third radiator 132.

In example embodiments, the first radiator 112 and the second radiator 122 may be arranged in a first direction. For example, the first radiator 112 and the second radiator 122 may be spaced apart from each other along a first axis X1 extending in the first direction. The first axis X1 may be an imaginary straight line passing through centers of the first radiator 112 and the second radiator 122 and extending in the first direction.

In example embodiments, the second radiator 122 and the third radiator 132 may be arranged in a second direction. For example, the second radiator 122 and the third radiator 132 may be spaced apart from each other along a second axis X2 extending in the second direction. The second axis X2 may be an imaginary straight line passing through centers of the second radiator 122 and the third radiator 132 and extending in the second direction.

For example, the first radiator 112, the second radiator 122 and the third radiator 132 may be spaced apart from each other, and may provide independent radiation properties and signal reception. Additionally, signal changes in the first direction and the second direction according to positional change of the sensing target may be measured. A motion and a moving distance of the sensing target may be detected through the measured signal changes.

In example embodiments, the first axis X1 and the second axis X2 may be perpendicular to each other. Thus, the antenna structure 100 may detect signal intensities in two axes X1 and X2 orthogonal to each other. For example, the antenna structure 100 may transfer changes of the signal intensities in the two orthogonal axes to a motion sensor driving circuit or a radar processor. Positional changes or distances in all directions on an X-Y coordinate system may be measured by the motion sensor driving circuit or the radar processor based on the collected information.

The antenna structure 100 may be used for a motion sensor for detecting motions and gestures or a radar for detecting the distance. The first radiation unit 110, the second radiation unit 120 and the third radiation unit 130 may be provided as reception radiation units. For example, the first radiator 112, the second radiator 122 and the third radiator 132 may serve as reception radiators for detecting the motion or the distance. For example, the first radiator 112, the second radiator 122 and the third radiator 132 may receive signals reflected from the sensing target.

The second radiation unit 120 may serve as a reference point for measuring signal changes in the first axis X1 and the second axis X2. For example, a change of the position of the sensing target may be sensed by measuring the changes of the signal intensities in the first axis X1 and the second axis X2 based on the signal intensity of the second radiation unit 120.

In some embodiments, each of the radiators 112, 122 and 132 may be designed to have a resonance frequency in a high frequency or ultra-high frequency band of, e.g., 3G, 4 G, 5G or higher. For example, the resonance frequency of each of the radiators 112, 122 and 132 may be about 50 GHz or higher, and may be, e.g., in a range from 50 GHz to 80 GHz, or from 55 GHz to 77 GHz.

In some embodiments, a spacing distance in the first direction between the first radiator 112 and the second radiator 122, and a spacing distance in the second direction between the second radiator 122 and the third radiator 132 may be substantially the same. In this case, the signal intensities in the first direction and the second direction may be measured at regular distance intervals. Accordingly, the signal changes in the first direction and the second direction according to the positional change of the sensing object may be more accurately measured.

In example embodiments, the first radiator 112, the second radiator 122 and the third radiator 132 may form the same polarization properties. For example, a polarization direction of the first radiator 112, a polarization direction of the second radiator 122 and a polarization direction of the third radiator 132 may be the same.

For example, if the first radiator 112 has a linear polarization property in a horizontal direction, the second radiator 122 and the third radiator 132 may also have the linear polarization property in the horizontal direction.

For example, if the first radiator 112 has a linear polarization property in a vertical direction, the second radiator 122 and the third radiator 132 may also have the linear polarization property in the vertical direction.

When a polarization direction of any one of the first radiator 112, the second radiator 122 and the third radiator 132 is different, a signal corresponding to the radiator having the different polarization direction may not be detected. For example, when the polarization direction of the third radiator 132 is different from the polarization direction of the first radiator 112 and the polarization direction of the second radiator 122, the positional change of the sensing target in the second direction may not be sensed.

According to embodiments of the present invention, the polarization direction of the first radiator 112, the polarization direction of the second radiator 122 and the polarization direction of the third radiator 132 are substantially the same, so that a signal sensitivity in the first direction and a signal sensitivity in the second direction may become uniform.

In example embodiments, the first transmission line 114 may be electrically connected to the first radiator 112. The second transmission line 124 may be electrically connected to the second radiator 122. The third transmission line 134 may be electrically connected to the third radiator 132.

For example, the first transmission line 114, the second transmission line 124 and the third transmission line 134 may transmit a driving signal or a power of an antenna driving integrated circuit (IC) chip to the first radiator 112, the second radiator 122 and the third radiator 132, respectively.

For example, the first transmission line 114, the second transmission line 124, and the third transmission line 134 may transfer an electromagnetic wave signal or electrical signal from the first radiator 112, the second radiator 122 and the third radiator 132, respectively, to the antenna driving IC chip, the motion sensor driving circuit or the radar processor.

The first radiator 112, the second radiator 122, and the third radiator 132 may be independently driven. Additionally, changes of an intensity of the electromagnetic wave signal along the first axis X1 and an intensity of the electromagnetic wave signal along the second axis X2 may be independently measured.

In some embodiments, the first transmission line 114, the second transmission line 124 and the third transmission line 134 may be disposed at the same layer or at the same level as that of the first radiator 112, the second radiator 122 and the third radiator 132, respectively.

The transmission lines 114, 124 and 134 may be disposed at the same level as that of the radiators 112, 122 and 132, so that feeding/driving may be performed without a separate coaxial power supply for signal input/output and feeding. Thus, for example, an antenna on display (AoD) in which the antenna structure 100 is disposed on a display panel may be implemented.

In some embodiments, the first transmission line 114, the second transmission line 124, and the third transmission line 134 may be disposed at different layers or at different levels from that of the first radiator 112, the second radiator 122 and the third radiator 132, respectively, on the dielectric layer 105.

In this case, the transmission lines 114, 124 and 134 and the radiators 112, 122 and 132 may be electrically connected to each other through a via.

In example embodiments, the transmission lines 114, 124 and 134 may include feeding portions 114a, 124a and 134a connected to the radiators 112, 122 and 132, and line portions 114b, 124b and 134b connected to the feeding portions 114a, 124a and 134a. For example, one end of the feeding portion 114a, 124a and 134a may be connected to the radiator 112, 122 and 132, and the other end of the feeding portion 114a, 124a and 134a may be connected to the line portion 114b, 124b and 134b.

The first transmission line 114 may include a first feeding portion 114a directly connected to the first radiator 112 and a first line portion 114b connected to an end portion of the first feeding portion 114a. The second transmission line 124 may include a second feeding portion 124a directly connected to the second radiator 122 and a second line portion 124b connected to an end portion of the second feeding portion 124a. The third transmission line 134 may include a third feeding portion 134a directly connected to the third radiator 132 and a third line portion 134b connected to an end portion of the third feeding portion 134a.

In example embodiments, polarization directions of the radiators 112, 122 and 132 may be controlled by a feeding direction from the transmission lines 114, 124 and 134 to the radiators 112, 122 and 132. For example, the polarization directions of the radiators 112, 122 and 132 may be determined according to extension directions of the feeding portions 114a, 124a, and 134a connected to the radiators 112, 122 and 132.

For example, when an extension direction of the first feeding portion 114a and an extension direction of the second feeding portion 124a are parallel to each other, the first radiator 112 and the second radiator 122 may have the same polarization properties.

In example embodiments, the first feeding portion 114a, the second feeding portion 124a and the third feeding portion 134a may extend to be parallel to each other. For example, as illustrated in FIG. 1, the first feeding portion 114a, the second feeding portion 124a and the third feeding portion 134a may extend in straight lines along the second direction.

In this case, the feeding direction to the first radiator 112, the feeding direction to the second radiator 122 and the feeding direction to the third radiator 132 may be parallel to each other. Accordingly, the polarization direction of the first radiator 112, the polarization direction of the second radiator 122 and the polarization direction of the third radiator 132 may be the same. The radiators may form the same polarization properties, so that reception efficiency of the antenna structure 100 may be enhanced and sensitivity to the motion or the distance of the sensing object may be improved.

In example embodiments, two of the first line portion 114b, the second line portion 124b and the third line portion 134b may have different feeding directions. For example, the feeding direction of the first line portion 114b and the feeding direction of the third line portion 134b may be different from each other. Thus, the first line portion 114b and the third line portion 134b may each extend to edges of the dielectric layer 105 while avoiding an area where the radiators 112, 122 and 132 are disposed on the dielectric layer 105.

In one embodiment, two of the first line portion 114b, the second line portion 124b and the third line portion 134b may extend to be parallel to each other, and the other may extend vertically to the two of the first to third line portions.

As one of the extending directions of the line portions 114b, 124b, and 134b connected to the external circuit structure or the driving IC chip is vertical, a degree of freedom in the antenna feeding design may be increased. Accordingly, the radiators 112, 122 and 132 may be easily disposed at a corner portion of the dielectric layer 105 or a corner portion of an image display device. For example, the corner portion may refer to a region where an edge in the width direction and an edge in the length direction of the dielectric layer 105 meet each other.

Further, lengths of the transmission lines 114, 124 and 134 may be decreased, so that a feeding distance between the radiators 112, 122 and 132 and the external circuit structure may be reduced, and thus signal and feeding loss may be suppressed.

For example, as illustrated in FIG. 1, an extension direction of the first line portion 114b and an extension direction of the second line portion 124b may be parallel to each other, and an extension direction of the third line portion 134b may be perpendicular to the extension direction of the first line portion 114b and the extension direction of the second line portion 124b.

In example embodiments, the third transmission line 134 may include a bent portion. The third feeding portion 134a and the third line part 134b may be divided by the bent portion. For example, the extension direction of the third feeding portion 134a and the extension direction of the third line portion 134b may be perpendicular to each other.

In one embodiment, each of the first transmission line 114 and the second transmission line 124 may extend in a straight line. For example, the first feeding portion 114a and the first line portion 114b may extend in the same direction. For example, the second feeding portion 124a and the second line portion 124b may extend in the same direction.

The extension direction of the first transmission line 114 and the extension direction of the second transmission line 124 may be parallel to each other. The extension direction of the third line portion 134b may be perpendicular to the extension direction of the first transmission line 114 and the extension directions of the second transmission line 124.

For example, the first transmission line 114, the second transmission line 124 and the third feeding portion 134a may extend in the second direction, and the third line portion 134b may extend in the first direction.

In example embodiments, the second transmission line 124 may also include a bent portion. Accordingly, the extension direction of the second feeding portion 124a and the extension direction of the second line portion 124b may be perpendicular to each other by the bent portion of the second transmission line 124.

For example, as illustrated in FIG. 2, the extension direction of the second line portion 124b and the extension direction of the third line portion 134b may be parallel to each other.

In one embodiment, the first transmission line 114 may extend in a straight line. For example, the first feeding portion 114a and the first line portion 114b may extend in the same direction. In this case, the extension direction of the first transmission line 114 may be perpendicular to the extension direction of the second line portion 124b and the extension direction of the third line portion 134b.

For example, the first transmission line 114, the second feeding portion 124a and the third feeding portion 134a may extend in the second direction, and the second line portion 124b and the third line portion 134b may extend in the first direction.

In example embodiments, the first direction may be parallel to a width direction of the dielectric layer 105, and the second direction may be perpendicular to the width direction of the dielectric layer 105.

In some embodiments, an imaginary straight line F1 extending along the first direction may include a bottom side of the first radiator 112 and a bottom side of the second radiator 122. An imaginary straight line F2 extending along the second direction may include a lateral side of the second radiator 122 and a lateral side of the third radiator 132. For example, the imaginary straight line F2 extending along the second direction may include right sides of the second radiator 122 and the third radiator 132 or left sides of the second radiator 122 and the third radiator 132.

In this case, the first radiator 112, the second radiator 122 and the third radiator 132 may be disposed to be adjacent to the corner portion of the dielectric layer 105. For example, the second radiator 122 among the first radiator 112, the second radiator 122 and the third radiator 132 may be the closest to the corner portion of the dielectric layer.

A distance between the radiator 112, 122 and 132 and the edge of the dielectric layer 105 may be decreased, so that the lengths of the transmission lines 114, 124 and 134 may be decreased. Thus, the feeding loss and signal reduction caused by the transmission lines 114, 124 and 134 may be prevented, and the antenna efficiency may be improved.

The antenna structure 100 may further include a fourth radiation unit 140 disposed to be spaced apart from the first radiation unit 110, the second radiation unit 120 and the third radiation unit 130.

The fourth radiation unit 140 may include a fourth radiator 142 and a fourth transmission line 144 connected to the fourth radiator 142 at the same layer as that of the fourth radiator 142.

The fourth radiation unit 140 may be provided as a transmission radiation unit of the antenna structure 100. For example, the fourth radiator 142 may be provided as a transmission radiator, and radiate an electromagnetic wave toward a sensing target. The first radiator 112, the second radiator 122 and the third radiator 132 may receive the electromagnetic wave signal reflected from the sensing target.

In example embodiments, the first radiator 112, the second radiator 122, the third radiator 132 and the fourth radiator 142 may have the same polarization properties. As the polarization directions of the reception radiators and the transmission radiator may coincide with each other, signal transmission and reception efficiency of the antenna structure 100 may be enhanced, and sensitivity and accuracy may be improved.

For example, when the first radiator 112, the second radiator 122, and the third radiator 132 have a linear polarization property in a vertical direction, the fourth radiator 142 may also have the linear polarization property in the vertical direction.

For example, when the first radiator 112, the second radiator 122 and the third radiator 132 have the linear polarization property in a horizontal direction, the fourth radiator 142 may also have the linear polarization property in the horizontal direction.

In some embodiments, the fourth transmission line 144 may include a fourth feeding portion 144a connected to the fourth radiator 142 and a fourth line portion 144b connected to the fourth feeding portion 144a.

The fourth feeding portion 144a may extend in parallel with the first feeding portion 114a, the second feeding portion 124a, and the third feeding portion 134a. Accordingly, the fourth radiator 142 may form the same polarization property as that of the first radiator 112, the second radiator 122 and the third radiator 132.

In example embodiments, the fourth transmission line 144 may extend in a straight line. For example, the fourth feeding portion 144a and the fourth line portion 144b may extend in the same direction. In one embodiment, the fourth feeding portion 144a and the fourth line portion 144b may be integral with each other.

Thus, a length of the fourth transmission line 144 may be decreased, thereby reducing a line resistance. Coverage and signal transmission/reception efficiency of the antenna structure 100 may be increased.

In example embodiments, the radiators 112, 122, 132 and 142 and/or the transmission lines 114, 124, 134 and 144 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the metals. These may be used alone or in a combination of at least two therefrom.

In an embodiment, the radiators 112, 122, 132 and/or 142 and the transmission lines 114, 124, 134 and 144 may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the radiators 112, 122, 132 and 142 and/or the transmission lines 114, 124, 134 and 144 may include a transparent conductive oxide such as indium tin oxide (ITO), indium zinc oxide (IZO), indium zinc tin oxide (ITZO), zinc oxide (ZnOx), etc.

In some embodiments, the radiators 112, 122, 132 and 142 and/or the transmission lines 114, 124, 134 and 144 may include a stacked structure of a transparent conductive oxide layer and a metal layer, and may include, e.g., a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The radiators 112, 122, 132 and 142 and/or the transmission lines 114, 124, 134 and 144 may include a blackened portion, so that a reflectance at a surface of the radiators 112, 122, 132 and 142 and/or the transmission lines 114, 124, 134 and 144 may be decreased to suppress a visual pattern recognition due to a light reflectance.

In an embodiment, a surface of the metal layer included in the radiators 112, 122, 132 and 142 and/or the transmission lines 114, 124, 134 and 144 may be converted into a metal oxide or a metal sulfide to form a blackened layer. In an embodiment, a blackened layer such as a black material coating layer or a plating layer may be formed on the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

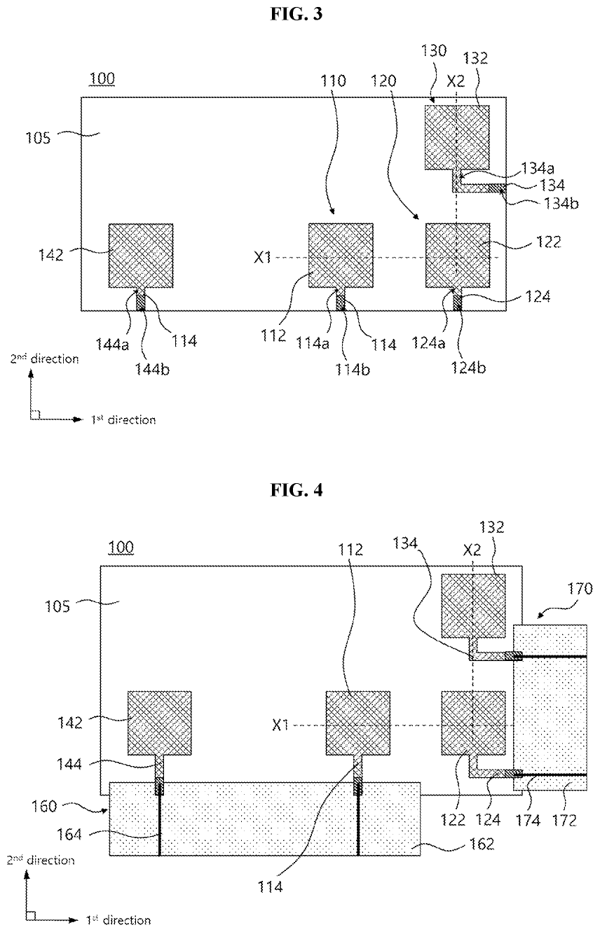

FIG. 3 is a schematic plan view illustrating an antenna structure in accordance with exemplary embodiments.

Referring to FIG. 3, the first radiator 112, the second radiator 122, the third radiator 132 and the fourth radiator 142 may each have a mesh structure. Accordingly, transmittance of the antenna structure 100 may be improved.

In example embodiments, the radiators 112, 122, 132 and 142 and the transmission lines 114, 124, 134 and 144 may entirely include the mesh structure. In one embodiment, at least a portion of the radiators 112, 122, 132 and 142 or at least a portion of the transmission lines 114, 124, 134 and 144 may include a solid structure to improve driving properties the antenna structure and enhance an impedance matching and the feeding efficiency.

For example, end portions of the transmission lines 114, 124, 134 and 144 may have a solid structure. In this case, the end portions of the transmission lines 114, 124, 134 and 144 may serve as signal pads.

In some embodiments, the first feeding portion 114a, the second feeding portion 124a, the third feeding portion 134a and the fourth feeding portion 144a may be formed as a mesh structure. The feeding portions 114a, 124a, 134a, and 144a adjacent to the radiators 112, 122, 132, and 142 may have the mesh structure, so that transmittance of the antenna structure 100 may be improved.

In some embodiments, the first line portion 114b, the second line portion 124b, the third line portion 134b and the fourth line portion 144b may have a solid structure. Accordingly, resistance of the transmission lines 114, 124, 134 and 144 may be reduced, and the signal and power loss may be prevented.

In some embodiments, at least a portion of the radiators 112, 122, 132 and 142 may have a solid structure. Accordingly, signal efficiency and antenna gain of the radiators 112, 122, 132, and 142 may be additionally improved. For example, a portion adjacent to an edge of the dielectric layer 105 of the radiators 112, 122, 132 and 142 may have the solid structure.

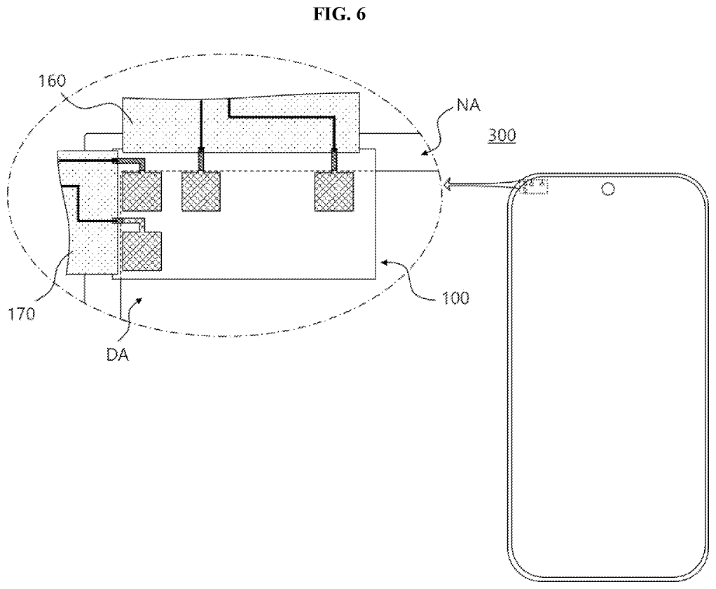

For example, as illustrated in FIG. 5, the first radiator 112 may have the solid structure at an side to which the first transmission line 114 is connected. The third radiator 132 may have the solid structure at a side physically separated from the third transmission line 134. The second radiator 122 may have the solid structure at two adjacent sides.

In this case, the first radiator 112, the second radiator 122 and the third radiator 132 may be efficiently disposed in a relatively narrow space. Accordingly, spatial efficiency may be improved when being applied to a display device having a narrow bezel area.

In some embodiments, the antenna structure 100 may further include a signal pad. The signal pad may be connected to each of the line portions 114b, 124b, 134b and 144b.

In one embodiment, the signal pad may be provided as a member substantially integral with the transmission lines 114, 124, 134 and 144. For example, one end portion of the transmission lines 114, 124, 134 and 144 may be provided as the signal pad.

In some embodiments, a ground pad may be disposed around the signal pad. For example, a pair of the ground pads may face each other with the signal pad interposed therebetween.

The ground pad may be electrically and physically separated from the transmission lines 114, 124, 134 and 144 and the signal pad.

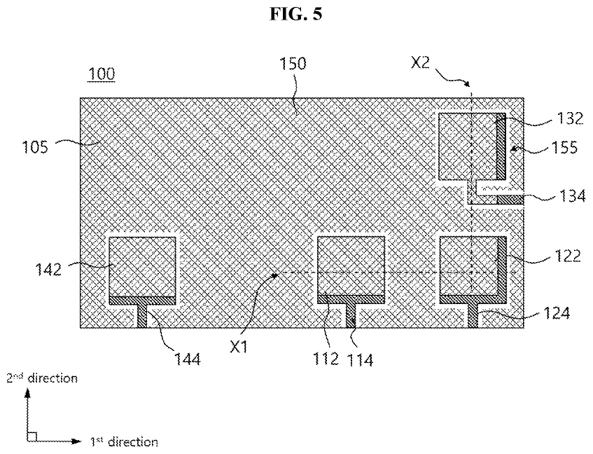

FIG. 4 is a schematic plan view illustrating an antenna structure in accordance with exemplary embodiments.

Referring to FIG. 4, the antenna structure 100 may include a first circuit board 160 and a second circuit board 170.

The first circuit board 160 may be disposed along an edge in a width direction of the dielectric layer 105. The second circuit board 170 may be disposed along an edge in a length direction of the dielectric layer 105.

When the second line portion 124b and the third line portion 134b extend in the same direction, the first circuit board 160 may be electrically connected to the first radiation unit 110, and the second circuit board 170 may be electrically connected to the second radiation unit 120 and the third radiation unit 130.

For example, when each of the first transmission line 114 and the fourth transmission line 144 extends in a straight line along the first direction, the first circuit board 160 may be electrically connected to the first radiation unit 110 and the fourth radiation unit 140.

When the first line portion 114b and the second line portion 124b extend in the same direction, the first circuit board 160 may be electrically connected to the first radiation unit 110 and the second radiation unit 120, and the second circuit board 170 may be electrically connected to the third radiation unit 130.

For example, when each of the first transmission line 114, the second transmission line 124 and the fourth transmission line 144 extends in a straight line along the first direction, the first circuit board 160 may be electrically connected to the first radiation unit 110, the second radiation unit 120 and the fourth radiation unit 140.

In some embodiments, one end portions of the transmission lines 114, 124, 134 and 144 may be connected to the radiators 112, 122, 132 and 142, and the other end portions of the transmission lines 114, 124, 134 and 144 may be bonded to the circuit boards 160 and 170.

For example, one ends of the line portions 114b, 124b, 134b and 144b may be connected to the feeding portions 114a, 124a, 134a and 144a, and the other ends of the line portions 114b, 124b, 134b, and 144b may be bonded to the circuit board 160 and 170.

The circuit boards 160 and 170 may include, e.g., a flexible printed circuit board (FPCB). For example, a conductive bonding structure such as an anisotropic conductive film (ACF) may be bonded onto the other end portions of the transmission lines 114, 124, 134, and 144, and then the circuit board 160 and 170 may be heat-compressed.

The circuit boards 160 and 170 may include core layers 162 and 172 and circuit wirings 164 and 174 disposed on the core layers 162 and 172. The circuit wirings 164 and 174 may be connected to the other end portions of the transmission lines 114, 124, 134 and 144 to serve as antenna feeding wirings.

For example, one end portions of the circuit wirings 164 and 174 may be exposed to an outside, and the exposed end portions of the circuit wirings 164 and 174 may be bonded to the transmission lines 114, 124, 134 and 144. Thus, the circuit wirings 164 and 174 and the radiation units 110, 120, 130 and 140 may be electrically connected to each other.

FIG. 5 is a schematic plan view illustrating an antenna structure in accordance with exemplary embodiments.

Referring to FIG. 5, the antenna structure 100 may further include a dummy mesh pattern 150 disposed around the first radiator 112, the second radiator 122, the third radiator 132 and the fourth radiator 142. For example, the dummy mesh pattern 150 may be electrically and physically separated from the radiators 112, 122, 132 and 142 and the transmission lines 114, 124, 134, and 144 by a separation region 155.

For example, a conductive layer containing the above-mentioned metal or alloy may be formed on the dielectric layer 105. A mesh structure may be formed while etching the conductive layer along profiles of the radiators 112, 122, 132 and 142 and transmission lines 114, 124, 134 and 144 as described above. Accordingly, the dummy mesh pattern 150 spaced apart from the radiators 112, 122, 132 and 142 and the transmission lines 114, 124, 134 and 144 by the separation region 155 may be formed

As the dummy mesh pattern 150 is distributed, optical properties around the radiators 112, 122, 132 and 142 may become uniform, and transmittance of the antenna structure 100 may be improved. Thus, the antenna structure 100 may be prevented from being visually recognized.

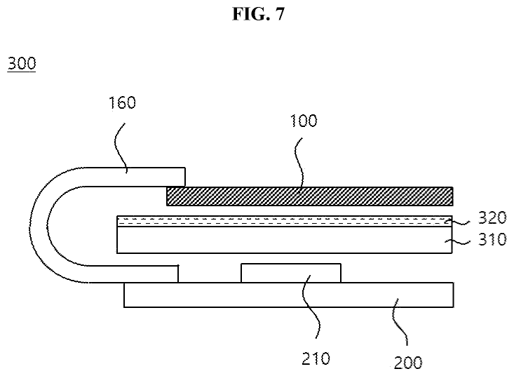

FIGS. 6 and 7 are a schematic plan view and a cross-sectional view illustrating an image display device in accordance with exemplary embodiments.

FIG. 6 illustrates a front portion or a window surface of the image display device 300. The front portion of the image display device 300 may include a display area DA and a non-display area NA. The non-display area NA may correspond to, e.g., a light-shielding portion or a bezel portion of the image display device 300.

The antenna structure 100 may be disposed toward the front portion of the image display device 300, and may be disposed on, e.g., a display panel.

Accordingly, the antenna structure 100 may detect a motion or an operation of a sensing target on the front portion of the image display device 300.

In some embodiments, the antenna structure 100 may be attached to the display panel in the form of a film.

In an embodiment, the antenna structure 100 may be formed throughout the display area DA and the non-display area NA of the image display device 300. In one embodiment, the radiators 112, 122, 132 and 142 may at least partially overlie the display area DA.

As described above, portions having the solid structure of the transmission lines 114, 124, 134 and 144 and the signal pad may be disposed in the non-display area NA. For example, the feeding portions 114a, 124a, 134a and 144a may be superimposed on the display area DA, and portions having the solid structure of the line portions 114b, 124b, 134b and 144b may be disposed in the non-display area NA.

In some embodiments, the antenna structure 100 may be positioned at a corner portion of the image display device 300. For example, the second radiator 122 may be disposed to be adjacent to the corner portion of the image display device 300 or the corner portion of the display panel.

The first direction of the antenna structure 100 may be parallel to a width direction of the image display device 300, and the second direction may be perpendicular to the width direction of the image display device 300.

In an embodiment, an imaginary straight line including a bottom side of the first radiator 112 and a bottom side of the second radiator 122 or an upper side of the first radiator 112 and an upper side of the second radiator 122 may be adjacent to an edge in the width direction of the display area DA. For example, referring to FIG. 6, the bottom side of the first radiator 112 and the bottom side of the second radiator 122 may be poisoned on the edge in the width direction of the display area DA

Additionally, an imaginary straight line including a right side of the second radiator 122 and a right side of the third radiator 132 or a left side of the second radiator 122 and a left side of the third radiator 132 may be adjacent to an edge in a length direction of the display area DA. For example, referring to FIG. 6, the right side of the second radiator 122 and the right side of the third radiator 132 may be positioned on the edge in the length direction of the display area DA.

The second radiator 122 may be adjacent to a vertex or a corner of the display area DA. Accordingly, a feeding distance between the radiators 112, 122, 132 and 142 and the circuit boards 160 and 170 may be decreased. Accordingly, the lengths of the transmission lines 114, 124, 134 and 144 may be decreased, and a motion sensing performance may be further improved by reducing the signal and power loss.

Referring to FIG. 7, the display device 300 may include a display panel 310 and the above-described antenna structure 100 disposed on the display panel 310. For convenience of descriptions, illustration of the second circuit board 170 is omitted in FIG. 7.

In example embodiments, the image display device may further include an optical layer 320 on the display panel 310. For example, the optical layer 320 may be a polarization layer including a polarizer or a polarizing plate.

In an embodiment, a cover window may be disposed on the antenna structure 100. The cover window may include, e.g., glass (e.g., ultra-thin glass (UTG)) or a transparent resin film. Accordingly, an external impact applied to the antenna structure 100 may be reduced or absorbed.

For example, the antenna structure 100 may be disposed between the optical layer 320 and the cover window. In this case, the dielectric layer 105 and the optical layer 320 disposed under the radiators 112, 122, 132 and 142 may commonly function as a dielectric layer of the radiators 112, 122, 132 and 142. Accordingly, an appropriate permittivity may be achieved so that the motion sensing performance of the antenna structure 100 may be sufficiently implemented.

For example, the optical layer 320 and the antenna structure 100 may be laminated through a first adhesive layer, and the antenna structure 100 and the cover window may be laminated through a second adhesive layer.

The circuit boards 160 and 170 of the antenna structure 100 may be bent along, e.g., a lateral side curved profile of the display panel 310 to be disposed at a rear portion of the display device 300 and extend toward an intermediate circuit board 200 (e.g., the main board) on which the driving IC chip is mounted. The intermediate circuit board 200 may be a rigid circuit board.

The circuit boards 160 and 170 and the intermediate circuit board 200 may be bonded or connected to each other through a connector, so that feeding and antenna driving control to the antenna structure 100 by the antenna driving IC chip may be implemented.

In some embodiments, a motion sensor driving circuit 210 may be mounted on the intermediate circuit board 200. In an embodiment, the motion sensor driving circuit 210 may include a proximity sensor, a gesture sensor, an acceleration sensor, a gyroscope sensor, a position sensor, a geomagnetic sensor, etc.

For example, the first circuit board 160 and the second circuit board 170 may be electrically connected to the intermediate circuit board 200, so that signal transmission/reception information of the antenna structure 100 may be transferred to the motion sensor driving circuit 210. Accordingly, a motion recognition sensor including the antenna structure 100 may be provided.

In some embodiments, the first radiation unit 110, the second radiation unit 120, the third radiation unit 130 and the fourth radiation unit 140 may be coupled to the motion sensor driving circuit 210. Accordingly, signal changes in the first axis X1 and the second axis X2 of the antenna structure 100 may be transmitted/provided to the motion sensor driving circuit 210. The motion sensor driving circuit 210 may measure the motion of the sensing target based on the signal information provided from the antenna structure 100.

For example, the motion of the sensing target in the first direction may be sensed by the second radiator 122 and the first radiator 112. The motion of the sensing target in the second direction may be sensed by the second radiator 122 and the third radiator 132.

In an embodiment, the motion sensor driving circuit 220 may include a motion detection circuit. Signal information transmitted from the antenna structure 100 may be converted/calculated into location information or distance information through the motion detection circuit.

In an embodiment, the antenna structure 100 may be electrically connected to a radar sensor circuit, and thus signal transmission/reception information may be transmitted to a radar processor. For example, the first circuit board 160 and the second circuit board 170 may be electrically connected to the radar processor through the intermediate circuit board 200. Accordingly, a radar sensor including the antenna structure 100 may be provided.

The radar sensor may analyze the transmission/reception signal to detect information about the sensing target. For example, the antenna structure 100 may transmit a transmission signal and receive the signal reflected by the sensing target to measure the distance to the sensing target.

For example, the distance of the sensing target may be calculated by measuring a time required for the signal transmitted from the antenna structure 100 to be reflected by the sensing target and received again by the antenna structure 100.

What is claimed is:

1. An antenna structure comprising:
a first radiation unit comprising a first radiator and a first transmission line, the first transmission line comprising a first feeding portion directly connected to the first radiator and a first line portion connected to an end of the first feeding portion;
a second radiation unit comprising a second radiator and a second transmission line, the second radiator having the same polarization direction as that of the first radiator, the second transmission line comprising a second feeding portion directly connected to the second radiator and a second line portion connected to an end of the second feeding portion; and
a third radiation unit comprising a third radiator and a third transmission line, the third radiator having the same polarization direction as that of the first radiator, the third transmission line comprising a third feeding portion directly connected to the third radiator and a third line portion connected to an end of the third feeding portion,
wherein the first radiator and the second radiator are arranged along a first direction, and the second radiator and the third radiator are arranged along a second direction perpendicular to the first direction, and
two of the first line portion, the second line portion and the third line portion have different feeding directions.

2. The antenna structure according to claim 1, wherein the first transmission line is disposed at the same layer as that of the first radiator, the second transmission line is disposed at the same layer as that of the second radiator, and the third transmission line is disposed at the same layer as that of the third radiator.

3. The antenna structure according to claim 1, wherein an extension direction of the first feeding portion, an extension direction of the second feeding portion and an extension direction of the third feeding portion are parallel to each other.

4. The antenna structure according to claim 3, wherein the third transmission line has a bent portion, and the extension direction of the third feeding portion and an extension direction of the third line portion are perpendicular to each other.

5. The antenna structure according to claim 4, wherein the first transmission line and the second transmission line each extends in a straight line, and
an extension direction of the first transmission line is parallel to an extension direction of the second transmission line, and is perpendicular to the extension direction of the third line portion.

6. The antenna structure according to claim 5, further comprising:
a first circuit board electrically connected to the first radiation unit and the second radiation unit; and
a second circuit board electrically connected to the third radiation unit.

7. The antenna structure according to claim 4, wherein the second transmission line has a bent portion,
the extension direction of the second feeding portion and an extension direction of the second line portion are perpendicular to each other, and
the extension direction of the second line portion is parallel to the extension direction of the third line portion, and is perpendicular to an extension direction of the first transmission line.

8. The antenna structure according to claim 7, further comprising:
a first circuit board electrically connected to the first radiation unit; and
a second circuit board electrically connected to the second radiation unit and the third radiation unit.

9. The antenna structure according to claim 1, further comprising a fourth radiation unit spaced apart from the first radiation unit, the second radiation unit and the third radiation unit.

10. The antenna structure according to claim 9, wherein the fourth radiation unit comprises a fourth radiator having the same polarization direction as that of the first radiator, and a fourth transmission line connected to the fourth radiator at the same layer as that of the fourth radiator.

11. The antenna structure according to claim 9, wherein the first radiation unit, the second radiation unit and the third radiation unit are provided as reception radiation units, and the fourth radiation unit is provided as a transmission radiation unit.

12. The antenna structure according to claim 1, further comprising a dielectric layer on which the first radiation unit, the second radiation unit and the third radiation unit are disposed, and
the first direction is parallel to a width direction of the dielectric layer, and the second direction is parallel to a length direction of the dielectric layer.

13. The antenna structure according to claim 12, wherein a bottom side of the first radiator and a bottom side of the second radiator are adjacent to an edge in the width direction of the dielectric layer, and
a lateral side of the second radiator and a lateral side of the third radiator are adjacent to an edge in the length direction of the dielectric layer.

14. The antenna structure according to claim 1, wherein the first radiator, the second radiator and the third radiator each has a mesh structure, and
the first transmission line, the second transmission line and the third transmission line each includes solid structure.

15. The antenna structure according to claim 14, wherein the first feeding portion, the second feeding portion and the third feeding portion each has a mesh structure, and
the first line portion, the second line portion and the third line portion each has the solid structure.

16. A motion recognition sensor comprising the antenna structure according to claim 1.

17. A radar sensor comprising an antenna structure according to claim 1.

18. An image display device, comprising:
a display panel; and
the antenna structure according to claim 1 disposed on the display panel.

19. The image display device according to claim 18, wherein the first direction is parallel to a width direction of the display panel, and the second direction is parallel to a length direction of the display panel, and
the second radiator among the first radiator, the second radiator and the third radiator is most adjacent to one of corner portions of the display panel.

20. The image display device according to claim 18, further comprising:
a motion sensor driving circuit coupled to the antenna structure; and
a flexible printed circuit board (FPCB) electrically connecting the antenna structure and the motion sensor driving circuit.
